(19) United States
(12) Patent Application Publication
(10) Pub. No.: US 2014/0200854 A1
(43) Pub. Date: Jul. 17, 2014

(54) METHODS AND COMPUTING SYSTEMS FOR SURVEY DESIGN AND MODELING WORKFLOW FOR TOWED MULTIMEASUREMENT SEISMIC STREAMER DATA

(71) Applicant: WESTERNGECO L.L.C., Houston, TX (US)

(72) Inventors: KURT EGGENBERGER, HOUSTON, TX (US); PHILIP A. F. CHRISTIE, FEN DRAYTON (GB); MASSIMILIANO VASSALLO, BRIGHTON (GB); DIRK-JAN VAN MANEN, REDHILL (GB)

(73) Assignee: WESTERNGECO L.L.C., HOUSTON, TX (US)

(21) Appl. No.: 14/156,373

(22) Filed: Jan. 15, 2014

Related U.S. Application Data
(60) Provisional application No. 61/752,638, filed on Jan. 15, 2013.

(51) Int. Cl. G01V 1/00

(52) U.S. Cl. CPC G01V 1/003
USPC 702/189

(57) ABSTRACT

Modular workflows for determining acquisition geometry and efficiency using 3D deghosting and wavefield reconstruction methods enabled by multicomponent seismic information are disclosed, which may be performed as methods. In some embodiments, such methods may be performed on computing systems.

### CROSS-REFERENCE TO RELATED APPLICATION

This application claims the benefit of U.S. Provisional Patent Application Ser. No. 61/752,638 filed Jan. 15, 2013, entitled, “Methods and Computing Systems for Survey Design and Modeling Workflow for Towed Multimeasurement Seismic Streamer Data,” which is hereby incorporated by reference in its entirety.

### BACKGROUND

Survey design and modeling is the process of evaluating prior data, if any, so as to optimize (or improve) the acquisition of a fresh seismic survey. For conventional marine seismic acquisition comprising pressure-only data acquisition, the process of converting geological objectives into a realizable, cost-effective survey is reasonably well understood. However, for towed marine multimeasurement seismic acquisition, the process is still being explored.

### SUMMARY

The computing systems, methods, processing procedures, techniques and workflows disclosed herein are more efficient and/or effective methods for identifying, isolating, transforming, and/or processing various aspects of seismic signals or other data that is collected from a subsurface region or other multi-dimensional space.

In accordance with some embodiments, a method is performed for developing a survey design for seismic acquisition that includes analyzing legacy seismic data; and reconstructing a wavefield based on at least the pressure gradient information.

In accordance with some embodiments, a method is performed for developing a survey design for seismic acquisition that includes analyzing legacy seismic data; and reconstructing a wavefield based on at least in part on the pressure information and the analyzed legacy seismic data.

In some embodiments, an aspect of the invention involves determining wavefield pressure gradient information from the legacy seismic data.

In some embodiments, an aspect of the invention involves processing seismic measurement data.

In some embodiments, an aspect of the invention includes that determining the wavefield pressure gradient information includes selecting one or more from the group consisting of: determining inline wavefield pressure gradient information, determining crossline wavefield pressure gradient information, and vertical wavefield pressure gradient information.

In some embodiments, an aspect of the invention includes that analyzing legacy seismic data includes analyzing either in a pre-stack domain or in a post-stack domain or both.

In some embodiments, an aspect of the invention includes that analyzing in a post-stack domain further comprises analysis of migrated 3D volumes of subsurface regions of interest.

In some embodiments, an aspect of the invention involves processing multimeasurement data when reconstructing the wavefield.

In some embodiments, an aspect of the invention involves evaluating the step of reconstructing the wavefield using seismic attributes and rock properties and using quality control metrics in a domain selected from a group comprising: a common shot gather domain, common offset domain, frequency domain, time domain, wavenumber domain, pre-stack domain, and post-stack domain.

In some embodiments, an aspect of the invention involves repeating the step of reconstructing the wavefield using a range of acquisition geometries.

In some embodiments, an aspect of the invention includes that the legacy seismic data includes data selected from a group consisting of multimeasurement towed streamer marine seismic data, dual-sensor towed streamer marine seismic data, over-under towed streamer marine seismic data, slanted-cable towed streamer marine seismic data, towed streamer seismic data, ocean bottom cable (OBC) seismic data, ocean bottom nodes (OBN) seismic data, land seismic data, data from permanent reservoir monitoring systems, borehole seismic data, and microseismic data.

In accordance with some embodiments, a method is performed for developing a survey design for seismic acquisition that includes performing any one of: deriving or estimating a wavefield velocity function; determining an emergence angle using at least the wavefield velocity function; and determining a first set of parameters associated with wavefield reconstruction.

In some embodiments, an aspect of the invention involves processing seismic measurement data.

In some embodiments, an aspect of the invention involves determining a second set of parameters associated with 3D deghosting.

In some embodiments, an aspect of the invention includes that the wavefield velocity function can be 1D, 2D, 3D or 4D.

In some embodiments, an aspect of the invention involves determining data receiver spacing.

In some embodiments, an aspect of the invention involves determining optimal streamer tow depth in the case of towed streamer marine seismic data.

In some embodiments, an aspect of the invention involves determining a streamer tow depth in the case of towed streamer marine seismic data.

In some embodiments, an aspect of the invention includes that determining a set of parameters further comprises determining interaction of aliasing and ghost notch frequencies with respect to one or more criteria selected from the group consisting of time, offset, and receiver spacing.

In some embodiments, an aspect of the invention includes that determining a set of parameters further comprises determining interaction of aliasing and ghost notch frequencies with time, offset, and receiver spacing.

In some embodiments, an aspect of the invention involves processing any one of a set consisting of: multi-measurement data, dual-sensor data and single sensor data.

In some embodiments, an aspect of the invention involves analyzing legacy seismic data.

In some embodiments, an aspect of the invention involves using one or more quality control metrics from a domain selected from the group consisting of frequency domain, time domain, wavenumber domain, pre-stack domain and post-stack domain.

In some embodiments, an aspect of the invention involves determining a range of acquisition geometries for the survey design.

In some embodiments, an aspect of the invention includes that seismic data used in the method is selected from the group consisting of multimeasurement towed streamer marine seismic data, dual-sensor towed streamer marine seismic data, over-under towed streamer marine seismic data, slanted-cable towed streamer marine seismic data, towed streamer seismic data, ocean bottom cable (OBC) seismic data, ocean bottom nodes (OBN) seismic data, land seismic data, data from permanent reservoir monitoring systems, borehole seismic data, and microseismic data.

In accordance with some embodiments, a method is performed for developing a survey design for seismic acquisition that includes determining geologic property models associated with geologic regions of interest; determining a synthetic set of associated seismic data; and reconstructing a wavefield using at least the synthetic set of associated seismic data.

In some embodiments, an aspect of the invention involves processing seismic measurement data.

In some embodiments, an aspect of the invention includes that determining the synthetic set includes performing one or more techniques selected from the group consisting of finite-difference modeling, finite element modeling, spectral element methods, tomography and ray tracing.

In some embodiments, an aspect of the invention involves determining one or more models selected from the group consisting of velocity models, density models, attenuation models, anisotropy models, and wave-heights models.

In some embodiments, an aspect of the invention involves performing 3D deghosting.

In some embodiments, an aspect of the invention involves using a noise model on at least a subset of acceleration components and pressure components.

In some embodiments, an aspect of the invention involves analyzing legacy seismic data.

In some embodiments, an aspect of the invention involves performing ray tracing.

In some embodiments, an aspect of the invention involves evaluating the step of reconstructing the wavefield using seismic attributes and rock properties; and using one or more quality control metrics from a domain selected from the group consisting of a common shot gather domain, common offset domain, migration domain and post migration domain, frequency domain, time domain, wavenumber domain.

In some embodiments, an aspect of the invention involves repeating the step of reconstructing the wavefield using a range of acquisition geometries.

In some embodiments, an aspect of the invention involves using a domain selected from a group comprising a common shot gather domain, common offset domain, migration domain and post migration domain.

In some embodiments, an aspect of the invention includes that the seismic data includes data selected from the group consisting of multimeasurement towed streamer marine seismic data, dual-sensor towed streamer marine seismic data, over-under towed streamer marine seismic data, slanted-cable towed streamer marine seismic data, towed streamer seismic data, ocean bottom cable (OBC) seismic data, ocean bottom nodes (OBN) seismic data, land seismic data, data from permanent reservoir monitoring systems, borehole seismic data, and microseismic data.

In some embodiments, a computing system is provided that comprises at least one processor, at least one memory, and one or more programs stored in the at least one memory, wherein the programs comprise instructions, which when executed by the at least one processor, are configured to perform any method disclosed herein.

In some embodiments, a computer readable storage medium is provided, which has stored therein one or more programs, the one or more programs comprising instructions, which when executed by a processor, cause the processor to perform any method disclosed herein.

In some embodiments, a computing system is provided that comprises at least one processor, at least one memory, and one or more programs stored in the at least one memory; and means for performing any method disclosed herein.

In some embodiments, an information processing apparatus for use in a computing system is provided, and that includes means for performing any method disclosed herein.

These systems, methods, processing procedures, techniques and workflows increase effectiveness and efficiency. Such systems, methods, processing procedures, techniques and workflows may complement or replace conventional methods for identifying, isolating, transforming and/or processing various aspects of seismic signals or other data that is collected from a subsurface region or other multi-dimensional space.

### BRIEF DESCRIPTION OF THE DRAWINGS

FIG. 1 illustrates an example computing system 100, according to certain embodiments.

FIG. 2 illustrates a high-level schematic of a framework, comprising legacy seismic data analysis workflow, ray-tracing workflow and seismic modeling workflow, according to certain embodiments.

FIG. 3 illustrates regions of interest, representing laterally changing structures identified and mapped in 3D, according to certain embodiments.

FIG. 4A illustrate a common shot gather and its computed inline gradient, according to certain embodiments.

FIG. 4B illustrates undecimated reference traces corresponding to reconstruction outputs, according to certain embodiments.

FIG. 4C illustrates output after pressure-only IMAP, according to certain embodiments.

FIG. 4D illustrates output after two-component MIMAP, according to certain embodiments.

FIG. 5 illustrates cross-line Nyquist frequency as a function of two-way-time and cross-line offset, according to certain embodiments.

FIG. 6 shows a SEG SEAM I model with a modeled pressure inline, and corresponding Vy zero-offset section for an arbitrary 4C common shot gather, according to certain embodiments.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

According to certain embodiments, the disclosed methods provide a framework of investigation, including modular workflows to optimize (or improve) the acquisition geometry and its efficiency without compromising on the survey objectives. In some embodiments, the disclosed methods and computing systems include a focus on 3D deghosting and wavefield reconstruction methods enabled by multicomponent seismic information.

According to certain embodiments, survey design and modeling (SD&M) is the process of evaluating prior data, if any, so as to optimize (or improve) the acquisition of a fresh seismic survey. For example, certain embodiments of the modular workflows are applicable to multicomponent seismic seabed data, and multicomponent seismic land data, in addition to the multicomponent seismic marine data, as described in greater detail herein. Further, certain embodiments of the modular workflows may be used with any seismic data such as seismic data associated with a single sensor, as a non-limiting example.

According to certain embodiments, wavefield reconstruction denotes any combination of interpolation and/or deghosting, using one, two or more wavefield components (recordings).

For conventional marine seismic acquisition comprising pressure-only data acquisition, the process of converting geological objectives into a realizable, cost-effective survey is reasonably well understood. However, towed marine multicomponent seismic acquisition requires a different approach from that which is appropriate for hydrophone-only acquisition.

According to certain embodiments, bandwidth enhancement between receiver positions overcoming higher order aliasing is a core value proposition of SD&M systems. It is the optimization (or improvement) of wavefield reconstruction and / or deghosting for SD&M using different levels of sophistication. In other words, designing a survey which takes advantage of wavefield reconstruction and/or deghosting to optimize the survey objectives represents at least some of the novel aspects discussed herein.

Certain embodiments disclosed herein provide a novel framework of investigation, including three modular workflows and appropriate quality control (QC) steps to evaluate reconstruction performance and to optimize (or improve) the acquisition geometry and its efficiency without compromising on the survey objectives. One part of such a framework is building the seismic model (e.g., building the physical property models of the subsurface regions of interest). The seismic model can range from simple to complex depending on the objectives of the survey, and the available resources. In some circumstances, when using a more complex and accurate seismic model, the processing can achieve a higher quality wavefield reconstruction and/or deghosting.

Wavefield reconstruction between individual receiver positions is used to overcome spatial aliasing and to improve temporal bandwidth for multicomponent seismic data, according to certain embodiments.

The performance of the wavefield reconstruction and deghosting based on multicomponent recordings is impacted by many factors such as the level of noise on the individual components, the streamer spacing, the streamer tow depth, the amplitude, frequency content and crossline dip of seismic events that, in turn, are affected by the subsurface geology. These factors impact the quality of wavefield reconstruction and deghosting as a function of interpolation distance. Therefore, in some conditions, it can be desirable to optimize (or improve) the acquisition design to ensure that the quality of the reconstructed wavefields is appropriate for the survey objectives.

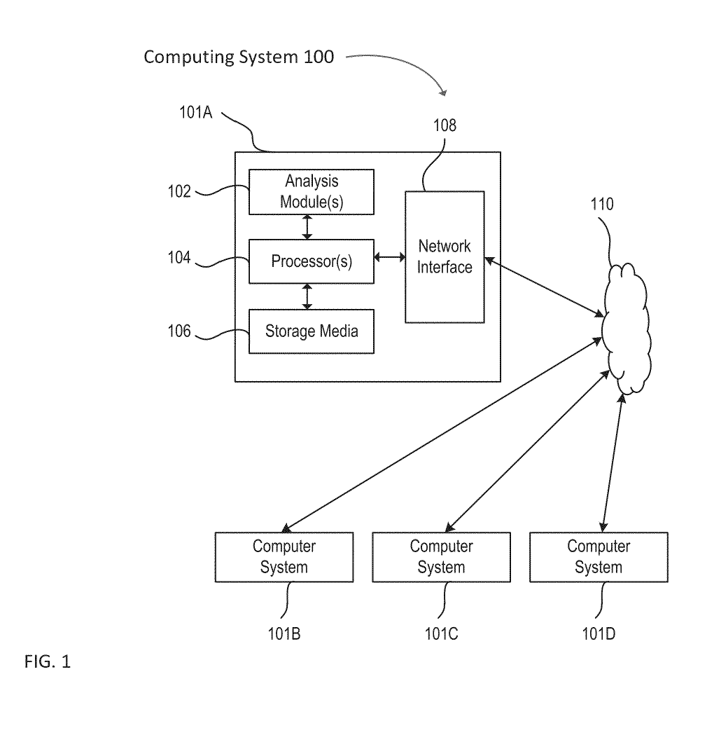

FIG. 1 depicts an example computing system 100, according to certain embodiments. The computing system 100 may be an individual computer system 101A or an arrangement of distributed computer systems. The computer system 101A includes one or more geosciences analysis modules 102 that are configured to perform various tasks according to some embodiments, such as one or more methods described herein. To perform these various tasks, geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D. Computer systems 101B, 101C and/or 101D may or may not share the same architecture as computer system 101A, and may be located in different physical locations. For example, computer systems 101A and 101B may be on a ship underway on the ocean, while in communication with one or more computer systems such as 101C and/or 101D that are located in one or more data centers on shore, on other ships, and/or located in varying countries on different continents. The data network 110 may be a private network, and it may use portions of public networks, and/or it may include remote storage and/or applications processing capabilities (e.g., cloud computing).

A processor may include a microprocessor, microcontroller, processor module or subsystem, programmable integrated circuit, programmable gate array, or another control or computing device.

The storage media 106 may be implemented as one or more computer-readable or machine-readable storage media. While in the example embodiment FIG. 1 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is only one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software or a combination of both, hardware and software, including one or more signal processing and/or application specific integrated circuits.

It should also be appreciated that while no user input/output peripherals are illustrated with respect to computer systems 101A, 101B, 101C, and 101D, many embodiments of computing system 100 include computing systems with keyboards, mice, touch screens, displays, etc. Some computing systems in use in computing system 100 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Attention is now directed to methods, techniques and workflows for processing and/or generating survey design and modeling that are in accordance with certain embodiments. Some operations in the processing procedures, methods, techniques and workflows disclosed herein may be combined and/or the order of some operations may be changed. It is important to recognize that in the geosciences, various geologic interpretations, sets of assumptions, and/or domain models such as velocity models, may be refined in an iterative fashion; this concept is applicable to the procedures, methods, techniques and workflows as discussed herein. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate.

A multimeasurement (multicomponent) towed seismic cable acquires pressure from a hydrophone and multiple orthogonally aligned components of particle acceleration. A non-limiting example of such a cable is described in, “On the use of multicomponent streamer recordings for reconstruction of pressure wavefields in the crossline direction” (Robertsson et al. 2008: Geophysics, 73(5), A45-A49), herein referred to as “Robertsson et al. 2008,” and which is incorporated by reference in its entirety. From acceleration, \dot{V}, the gradient of pressure, ∇P, can be derived using the relation: ∇P=−ρ\dot{V}, where the dot denotes time derivative. Two axially-orthogonal components are needed to span the space perpendicular to the streamer axis, but only the vertical component, Vz, is needed to perform up/down wavefield separation. An equivalent measurement to Vx can be obtained directly from the in-line gradient of pressure, P. One application for Vy lies in its potential to overcome higher order aliasing in the cross-line direction with respect to pressure-only data. Non-limiting examples of such an application for Vy are described in, “A discussion of sampling theorems. Proceedings of the Institute of Radio Engineers Linden 1959: 47, 1219-1226), herein referred to as “Linden 1959”, and which is incorporated by reference in its entirety; “Crossline wavefield reconstruction from multicomponent streamer data: Part 2—Joint interpolation and 3D up/down separation by generalized matching pursuit” (Özbek et al., 2010: Geophysics, 75, WB69-WB85), herein referred to as “Özbek et al., 2010”, and which is incorporated by reference in its entirety; Robertsson et al. 2008.

The potential to double the Nyquist wavenumber has an immediate benefit in conventional wavefield interpolation but methods such as multi-channel interpolation by matching pursuit (see “Crossline wavefield reconstruction from multicomponent streamer data, Part 1: Interpolation by matching pursuit using pressure and its crossline gradient.” Geophysics, 75, WB53-WB67, herein referred to as “MIMAP” or “Vassallo et al., 2010,” and which is incorporated by reference in its entirety) can reconstruct the total pressure wavefield beyond the Nyquist wavenumber by matching both pressure and its cross-line gradient, Vy. Joint interpolation and deghosting, whereby the upgoing pressure wavefield is estimated at an arbitrary point within an aperture of multimeasurement streamers, may be achieved through a generalized matching pursuit algorithm (GMP) that simultaneously models the acquired data P, Vz and Vy (Özbek et al., 2010).

Studies on both synthetic and real seismic data have shown in a qualitative and quantitative manner that these methods are robust (for example, “The fidelity of 3D wavefield reconstruction from a four-component marine streamer and its implications for time-lapse seismic measurements”, Eggenberger et al., 2012: 82nd Meeting Society of Exploration Geophysicists, Expanded Abstract, doi: 10.1190/segam2012-0908.1, herein referred to as “Eggenberger et al., 2012”, and which is incorporated by reference in its entirety); Özbek et al., 2010). However, the performance of such methods in the presence of noise depends, amongst other things, on the streamer spacing, the streamer tow depth, and the frequency content and crossline dip of seismic events, which in turn are affected by the subsurface geology. This translates into a dependency on interpolation distance and, therefore, it is desirable to optimize (or improve) the acquisition geometry before the actual survey, based on survey objectives. Such work is not well understood for acquisition using multimeasurement streamers. A framework of survey evaluation and design to address this challenge is described herein. Such work is based on prior information such as legacy seismic data and models of the physical properties of the subsurface. Such properties of the subsurface then can be utilized in finite difference modeling to mimic the earth response for a range of geometries, to assess the reconstruction performance and to streamline acquisition geometry for the needs of the survey.

### Framework

The description herein describes towed multimeasurement seismic in detail.

Certain embodiments as described herein disclose a framework of survey evaluation and design that includes three workflows to address the challenge of SD&M where the centerpiece of investigation deals with wavefield reconstruction of any kind with the aim to overcome (or at least mitigate) bandwidth constraints. Such SD&M work is based on prior information such as legacy seismic data and models of the physical properties of the subsurface. Property models can be used in finite difference modeling to mimic the earth response for a range of geometries, to assess the reconstruction performance and to streamline acquisition geometry for the needs of the survey which can, for instance, comprise illumination, time-lapse signal, efficiency or a combination thereof. It is also possible to evaluate the uplift that wavefield reconstruction brings to a given acquisition scenario in a vertically integrated manner. For example, full waveform modeling can generate individual shots, or 2D and 3D surveys, for processing through migration, waveform inversion and rock property estimation, evaluating the end products and testing appropriate processing flows in advance of the actual acquisition.

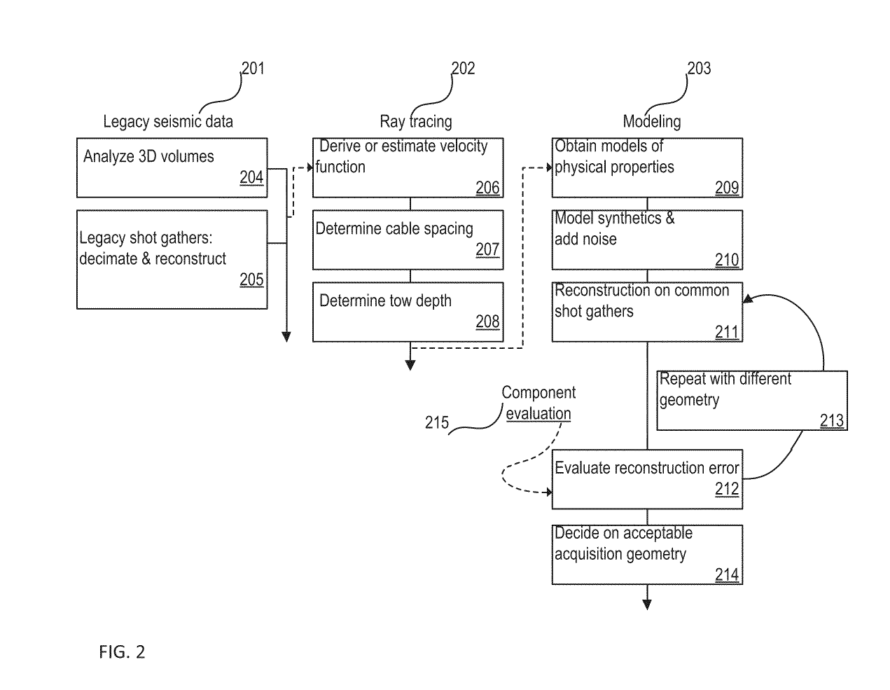

FIG. 2 illustrates a high-level schematic of such a framework, comprising the three workflows of legacy seismic data analysis workflow (201), ray-tracing workflow (202), and seismic modeling workflow (203) that can be combined and sequenced in a modular fashion, as well as being combined with other techniques and methods as appropriate, according to certain embodiments.

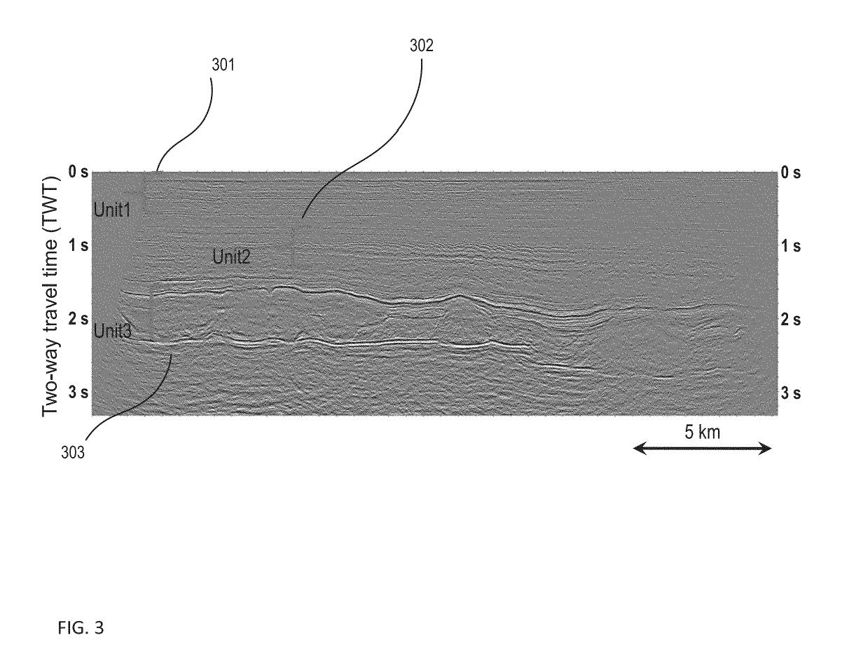

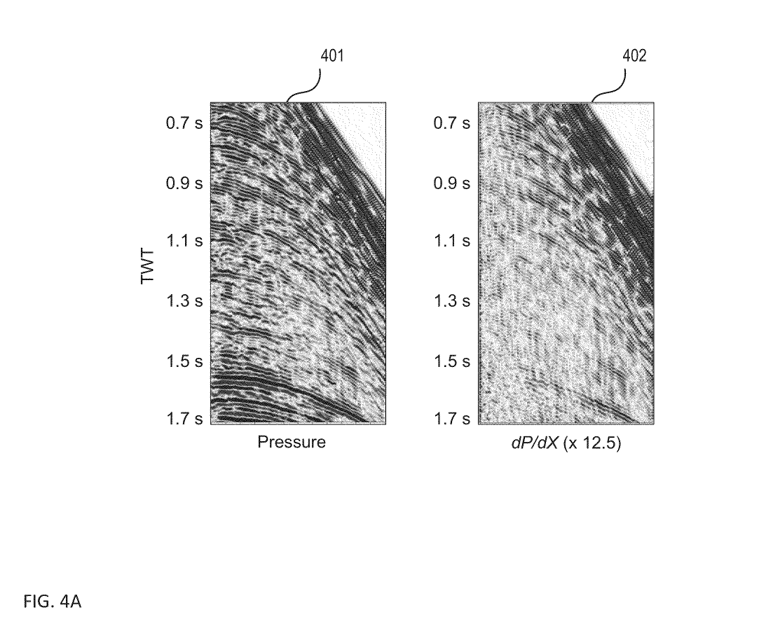

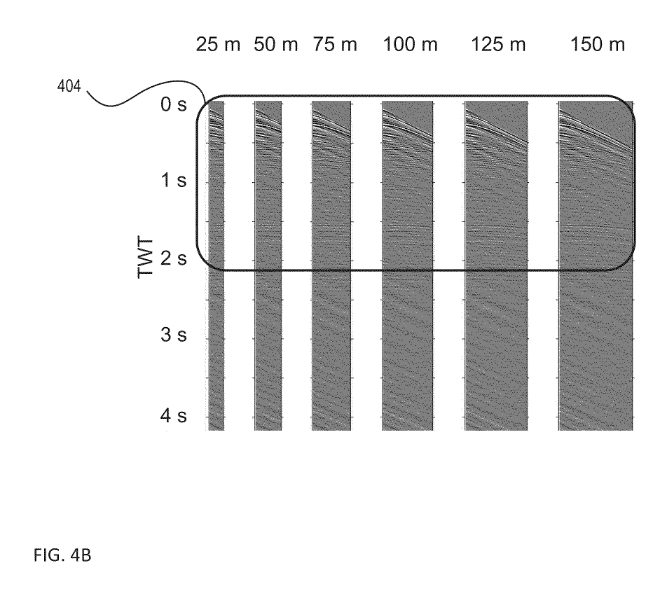

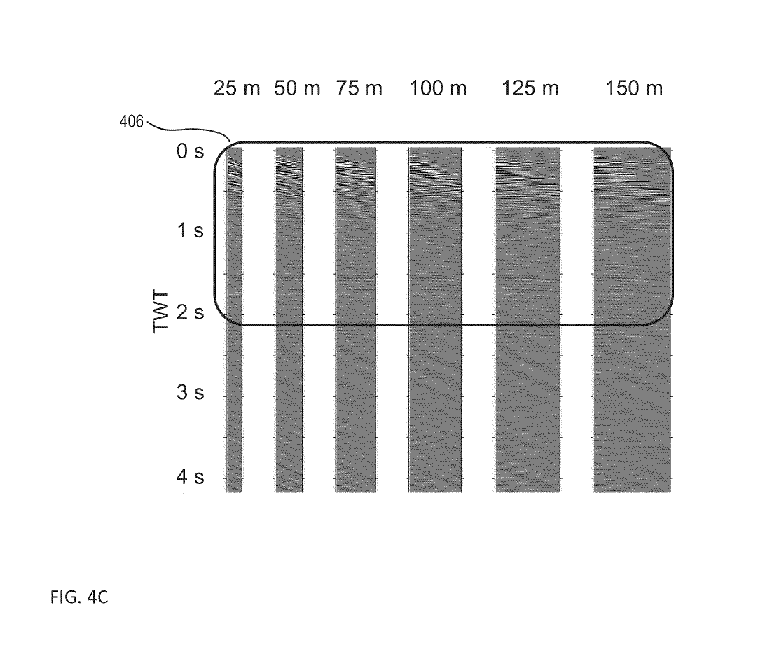

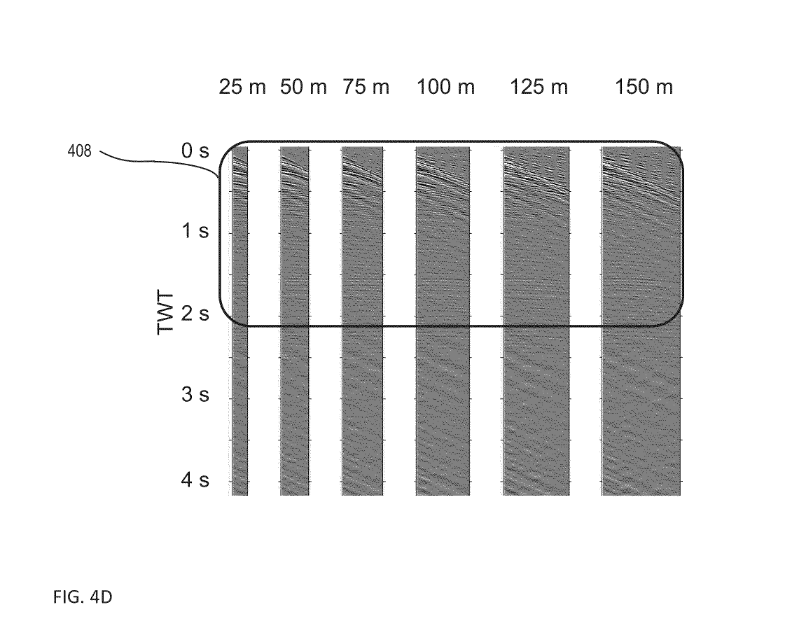

In FIG. 2, at step 204, legacy 3D volume data can be analyzed in order to understand its characteristics, such as signal bandwidth and time dip, and identify regions of interest (for example, see FIG. 3 as described herein). At step 205, inline gradient information can be computed on legacy shot gathers by decimating pressure and/or gradient data and then reconstructing the associated wavefield (for example, see FIGS. 4A-D as described herein).

According to certain embodiments, the findings from the legacy seismic data analysis workflow (201) can be input into the seismic ray-tracing workflow (202). At step 206, findings from the legacy seismic data analysis workflow (201) can be used to estimate the velocity function, which, together with the expected signal bandwidth and time-dip can, in turn, be used to determine optimal (or suitable) spacing of the streamers (cable spacing) at step 207, and determine optimal (or suitable) tow depth at step 208. According to certain embodiments, the velocity function can be of varied complexity, e.g., 1D, 2D, 3D or 4D.

According to certain embodiments, the findings from the seismic ray-tracing workflow (202) can be input into the seismic modeling workflow (203). At step 209, physical property models of the subsurface are obtained. At step 210, a synthetic data model is generated using a range of realistic additive noise fields. At step 211, the wavefield is reconstructed on the shot gathers. At step 212, reconstruction errors are evaluated. According to certain embodiments, the wavefield reconstruction and error evaluation loop can be repeated on the modeled data for a range of acquisition geometries (step 213). According to certain embodiments, wavefield reconstruction can take into account seismic attributes such as rock porosity. At step 214, a decision can be made on the optimal (or suitable, or acceptable) acquisition geometry.

The steps shown are merely illustrative and do not necessarily represent the full breadth of survey design and modeling involved for multicomponent data. For instance the modeling, wavefield reconstruction and evaluation can comprise different levels of complexity, which can extend through imaging into the post-stack domain for analysis. For example, the level of complexity may depend on the objectives of the survey project, the available resources, the risk tolerance and/or the amount of time available for the survey project.

Those with skill in the art, however, will appreciate that the methods and computing systems disclosed herein may also be employed with dual-sensor towed streamer marine seismic data, over-under towed streamer marine seismic data, slanted-cable towed streamer marine seismic data, towed streamer seismic data, land seismic data, ocean bottom cable seismic (OBC), ocean bottom nodes (OBN), and semi-permanent or permanent reservoir monitoring systems where it is sought to overcome the sparsity of spatial sampling into one or more dimensions, using multichannel wavefield reconstruction, deghosting, and/or demultiple techniques.

Furthermore, the example framework in FIG. 2 is associated with common shot gathers in the modeling workflow (203) for reconstruction, demultiple processing, and/or deghosting, together with the quality assessment. However, similar analysis can be performed in different data domains as well, including the non-limiting examples of common offset and migration domains, to name a few. Those with skill in the art will appreciate that the modeling and ray tracing can be augmented by more complexities like irregular sampling, modeling of the near surface currents in the marine case, 4D effects and anisotropy of all kinds.

Those with skill in the art will also appreciate that the framework discussed herein may be supplemented with appropriate quality control measures to determine the quality of the reconstruction, demultiple processing, and/or deghosting techniques as applied. A non-exclusive list of such measures can contain 4D metrics like Normalized Root Mean Square (NRMS) and predictability (see for example, “Seismic repeatability, normalized RMS, and predictability,” The Leading Edge, Kragh and Christie, 2002: 21(7), pp. 640-647), also in a frequency dependent mode, and f-k plots in 2D and 3D. Quality control metrics can be performed in a variety of domains such as frequency domain, time domain, wavenumber domain, pre-stack domain and post-stack domain.

Additionally, those with skill in the art will appreciate that many forms of input models may be used for seismic modeling successfully with the example framework, methods, computing systems, and techniques disclosed herein, including the following non-limiting examples, velocity models, anisotropy models (utilizing delta and epsilon), Q-models relating to 3D attenuation, etc. In some embodiments, a plurality of input models may be used for seismic modeling to increase accuracy of the results.

### Legacy Seismic Data Workflow

Often, legacy seismic data are available in survey areas of interest. For the purpose of wavefield reconstruction, these data can be analyzed in two complementary domains: pre-stack and post-stack. The post-stack analysis deals with final migrated 3D volumes of the subsurface where individual regions of the subsurface—the reservoir, but also the over- and underburden—are investigated in terms of geological features.

For purposes of illustration, FIG. 3 shows the legacy data analysis performed prior to a towed multimeasurement survey in the North Sea as part of an experimental test. Three horizons of interest (301, 302, 303), representing laterally changing structures were identified and mapped in 3D because a complex geology can generate out of plane energy, detail which is easily lost in a conventional survey. In FIG. 3, area of interest 301 is near seabed heterogeneity, area of interest 302 comprises tilted fault blocks around is two-way time, and area of interest 303 covers Zechstein salt pillows around 2s. Conventional survey design and evaluation sought to minimize the out-of-plane energy, especially from the reservoir. This largely dictated the acquisition azimuth, which also compromised the illumination detail. However, survey illumination objectives are not focused solely on the reservoir; it is important to have a good understanding of the overburden, as ultimately the drill bit will penetrate those rock formations to access the reservoir. With the recent emergence of 3D deghosting and wavefield reconstruction enabled by towed multimeasurement seismic, this azimuthal limitation can be relaxed, allowing for more flexible survey design. However, the acquisition geometry needs to adhere to good reconstruction quality. Thus, the evaluation of reconstruction error as described herein with respect to FIG. 2 is one of the novel aspects of certain embodiments. The pre-stack analysis of legacy data can give a valuable first insight to the complexity of the recorded wavefield. The inline pressure wavefield is well sampled on most seismic cables allowing computation of the inline pressure gradient on common shot gathers for input to the MIMAP wavefield reconstruction algorithm. This methodology was first described in “Evaluating the benefit of pressure-plus-gradient reconstruction of time-lapse seismic wavefields” (Eggenberger et al. 2011: 73^{rd} Meeting European Association of Geoscientists & Engineers, Extended Abstract, H015), herein referred to as “Eggenberger et al. 2011”, and which is incorporated by reference in its entirety.

FIG. 4A shows a common shot gather (401) and its computed inline gradient (402) with 12.5 m receiver interval. To guide cable spacing selection, both pressure and gradient data were decimated to six input traces of 25 m-125 m sampling, in 25 m increments, and reconstructed using both single- and multi-channel matching pursuit algorithms (IMAP and MIMAP). For IMAP, see “Interpolation of irregularly sampled data by matching pursuit,” (Özdemir, K., Özbek, A., Vassallo, M., 2008: 70th Meeting European Association of Geoscientists & Engineers, Extended Abstract, G025). FIG. 4B shows that undecimated reference traces can be compared with traces reconstructed by output after pressure-only IMAP shown in FIG. 4C and output after two-component MIMAP shown in FIG. 4D. In FIGS. 4A-D, the regions of greatest interest or difference are marked with a box (404, 406, 408), from 1-3 s and from 25-100 m, corresponding to the interval from the seabed to the base of unit 3. The higher the separation of the six streamers, the more samples will be reconstructed to get back to 12.5 m trace sampling. The uplift from the additional gradient component is evident and may be quantified using repeatability metrics (Eggenberger et al., 2011). The box (404, 406, 408) highlights the areas of interest, corresponding to the three areas identified in FIG. 3, herein.

### Ray Tracing Workflow

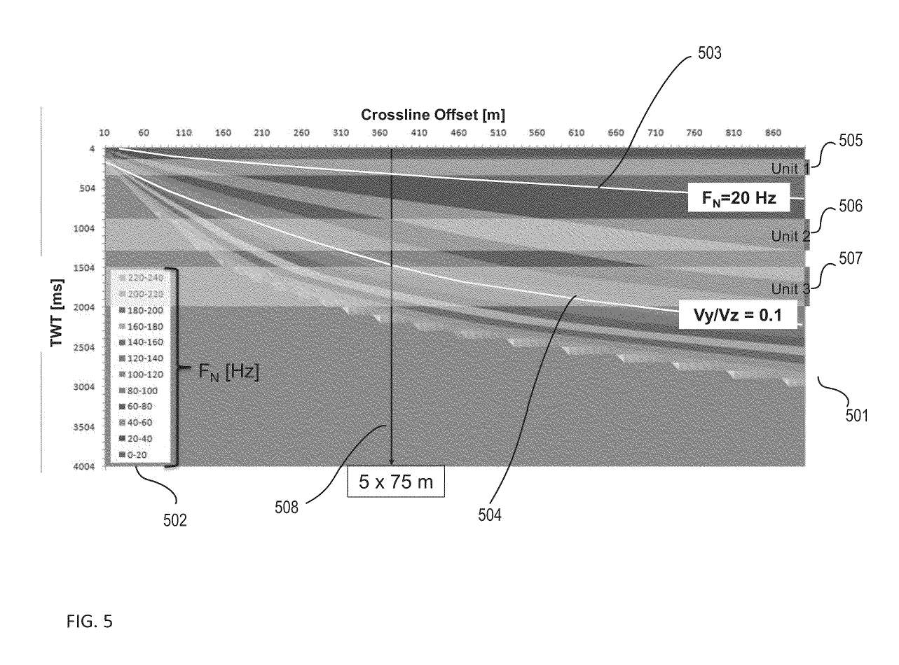

The legacy seismic data analysis can guide both waveform modeling and ray tracing. The latter can provide a quick look at cable spacing and the bandwidth over which multi-channel reconstruction may be expected to provide uplift, and identify the interaction of aliasing and ghost notch frequencies with time, offset, and cable spacing, as shown in FIG. 5, using a 1D velocity function, as a non-limiting example, from the legacy data set in FIG. 3.

FIG. 5 illustrates pressure-only cross-line Nyquist frequency as a function of two-way-time and cross-line offset, according to certain embodiments. The wedges (501) in FIG. 5 map the variation of the effective crossline Nyquist frequency (502), imposed by an asymmetric configuration of six cables at 75-m cable spacing and a source inline with cable 1, in 20 Hz bands from 0 Hz (blue) to 240 Hz (brown). Accelerometer noise increases to lower frequencies, where its use can be limited, so an arbitrary cut off frequency is shown by the upper white line (503). A lower white line (504) indicates the threshold where the amplitude ratio Vy/Vz falls below 0.1. The three areas of interest or target units from FIG. 3 are indicated as translucent bands edged in bars (505, 506, 507). The vertical line (508) marks the offset limit of specular reflections in a 1D earth. Crossline dip and diffractions can vary the effective offset so the region beyond the red line is also of interest. FIG. 5 may be interpreted to identify the regions in crossline offset and two-way time where contributions from the accelerometer components will be required to achieve dealiased reconstruction of reflected and diffracted wavefields. FIG. 5 also indicates the expected order of aliasing at given target zones and whether the anticipated signal to noise ratio, especially for crossline acceleration, may enable dealiased wavefield reconstruction. Finally, the FIG. 5 may also help to analyze the interaction within target zones of effective Nyquist frequency with tow-depth ghost notches from source, hydrophone and accelerometer.

In some embodiments, one parameter provided by the ray-tracing is the 3D emergence angle of the wavefield. With the known medium velocity, this angle can be used to determine the wavenumber vector which controls the accelerometer response. This can narrow the range of effective cable spacing and can enable initial estimates of signal-to-noise ratios, especially for accelerometers. More sophisticated 2D or 3D ray tracing can explore a specific structure, if the velocity field is known. Furthermore, in some embodiments, a ray tracer with incorporated reconstruction and deghosting algorithm can directly produce targeted quality metrics, and in some embodiments, in 4D.

### Seismic Modeling Workflow

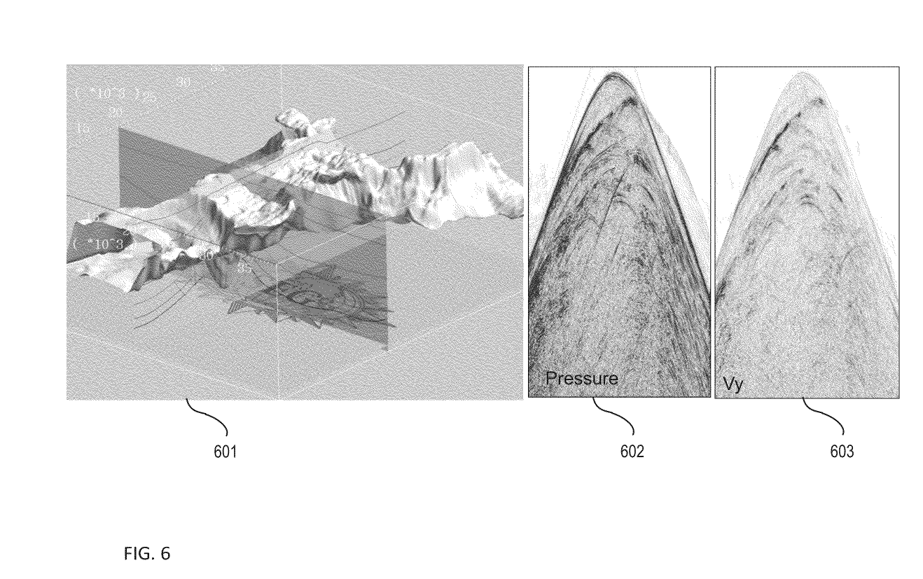

Legacy seismic data can guide waveform modeling since 3D velocity models are often available which approximate the main geological features. Physical property models of the subsurface are also generated prior to a seismic survey by combining seismic, well-log and geological information. The third workflow (203 of FIG. 2) uses velocity and density models as input to finite difference modeling. Attenuation models and wave-heights models can also be used. Modern computing hardware combined with extrapolation kernels makes possible the production-scale use of finite difference modeling. Non-limiting examples of applications in accordance with some embodiments include the accurate modeling of surveys over complex structures, comparison of different acquisition scenarios for survey analysis and design, and generating synthetic data for evaluation of data conditioning or migration workflows. In some embodiments, the modeling software applied employs a staggered-grid velocity-stress implementation of the finite-difference time-domain algorithm. It combines good dispersion characteristics with efficient incorporation of heterogeneous density fields. Since particle velocity is explicitly given by the velocity-stress implementation, it can be sampled efficiently to produce accurate multi-channel output as shown in FIG. 6. FIG. 6 shows the SEG SEAM I model (601), a modeled pressure inline (602) and corresponding Vy zero-offset section (603) for an arbitrary 4C common shot gather.

In some embodiments, once shot locations, appropriate for the geological challenge, are selected, they are modeled using an initial acquisition geometry and a range of realistic additive noise fields. In some embodiments, the trial wavefield reconstructions cover single- and multi-channel algorithms to evaluate the uplift achieved through the additional acceleration measurements. In some embodiments, reconstruction performance may be evaluated using 4D metrics against undecimated reference synthetics in conjunction with spectral analysis and frequency-wavenumber plots in both 2D and 3D. This loop may then be repeated on the modeled data for a range of acquisition geometries, changing cable separation to optimize (or improve) reconstruction performance and operational efficiency while addressing the survey objectives.

As those with skill in the art will appreciate, the seismic modeling may be performed in the common shot gather domain, the common offset domain, the migration domain, post migration domain or any domain suitable to exercise the multichannel wavefield reconstruction, demultiple processing, and/or deghosting algorithms.

Survey evaluation and design for a towed marine multimeasurement survey requires a different approach than for hydrophone-only acquisition, focusing on crossline wavefield reconstruction between streamer positions. To optimize (or increase) acquisition efficiency without compromising the survey objectives, the described framework is based on a combination of one or more of three pillars: legacy data analysis, ray tracing to explore geometry impact, and full wavefield modeling to evaluate reconstruction performance. Production-scale finite difference modeling provides a powerful workflow to optimize (or improve) wavefield reconstruction parameters and thus guide the acquisition effort.

According to certain embodiments, multimeasurement streamer processing includes performing legacy seismic data processing on the seismic data corresponding to a region of interest.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

While the discussion of related art in this disclosure may or may not include some prior art references, applicant neither concedes nor acquiesces in the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A method for developing a survey design for seismic acquisition, comprising:
analyzing legacy seismic data; and
reconstructing a wavefield based on at least the pressure gradient information.

2. The method of claim 1, further comprising determining wavefield pressure gradient information from the legacy seismic data.

3. The method of claim 1, further comprising processing seismic measurement data.

4. The method of claim 2, wherein determining the wavefield pressure gradient information includes selecting one or more from the group consisting of: determining inline wavefield pressure gradient information, determining crossline wavefield pressure gradient information, and vertical wavefield pressure gradient information.

5. The method of claim 1, wherein analyzing legacy seismic data includes analyzing either in a pre-stack domain or in a post-stack domain or both.

6. The method of claim 5, wherein analyzing in a post-stack domain further comprises analysis of migrated 3D volumes of subsurface regions of interest.

7. The method of claim 1, further comprising processing multimeasurement data when reconstructing the wavefield.

8. The method of claim 1, further comprising processing single sensor data when generating a comparison volume from the single sensor data.

9. The method of claim 1, further comprising evaluating the step of reconstructing the wavefield using seismic attributes and rock properties and using quality control metrics in a domain selected from a group comprising: a common shot gather domain, common offset domain, frequency domain, time domain, wavenumber domain, pre-stack domain, and post-stack domain.

10. The method of claim 1, further comprising repeating the step of reconstructing the wavefield using a range of acquisition geometries.

11. The method of claim 1, wherein the legacy seismic data includes data selected from a group consisting of multimeasurement towed streamer marine seismic data, dual-sensor towed streamer marine seismic data, over-under towed streamer marine seismic data, slanted-cable towed streamer marine seismic data, towed streamer seismic data, ocean bottom cable (OBC) seismic data, ocean bottom nodes (OBN) seismic data, land seismic data, data from permanent reservoir monitoring systems, borehole seismic data, and microseismic data.

12. A method for developing a survey design for seismic acquisition, comprising:
performing any one of: deriving or estimating a wavefield velocity function;
determining an emergence angle using at least the wavefield velocity function; and
determining a first set of parameters associated with wavefield reconstruction.

13. The method of claim 12, further comprising determining a second set of parameters associated with 3D deghosting.

14. The method of claim 12, further comprising determining data receiver spacing.

15. The method of claim 12, further comprising determining a streamer tow depth in the case of towed streamer marine seismic data.

16. The method of claim 12, further comprising processing any one of a set consisting of: multi-measurement data, dual-sensor data and single sensor data.

17. The method of claim 12, further comprising determining a range of acquisition geometries for the survey design.

18. A method for developing a survey design for seismic acquisition, comprising:
determining geologic property models associated with geologic regions of interest;
determining a synthetic set of associated seismic data; and
reconstructing a wavefield using at least the synthetic set of associated seismic data.

19. The method of claim 18, further comprising performing 3D deghosting.

20. The method of claim 18, further comprising using a noise model on at least a subset of acceleration components and pressure components.

21. The method of claim 18, further comprising analyzing legacy seismic data; and performing ray tracing.

22. The method of claim 18, further comprising evaluating the step of reconstructing the wavefield using seismic attributes and rock properties; and using one or more quality control metrics from a domain selected from the group consisting of a common shot gather domain, common offset domain, migration domain and post migration domain, frequency domain, time domain, wavenumber domain.

23. The method of claim 18, further comprising repeating the step of reconstructing the wavefield using a range of acquisition geometries.
